(19) United States
(12) Patent Application Publication
(10) Pub. No.: US 2026/0138742 A1
(43) Pub. Date: May 21, 2026

(54) SYSTEM AND METHODS FOR TIRE DEFLATION DEVICE, UNMANNED AERIAL SYSTEMS (UAS) INTEGRATION, AND ASSOCIATED SOFTWARES

(71) Applicant: Myles Brennan Ainley, Paragould, AR (US)

(72) Inventor: Myles Brennan Ainley, Paragould, AR (US)

(21) Appl. No.: 18/949,992

(22) Filed: Nov. 16, 2024

(51) Int. Cl. B64D 1/02; B64U 50/37; B64U 80/25; B64U 101/16; E01F 13/12; G05B 13/02

(52) U.S. Cl. CPC B64D 1/02; B64U 50/37; B64U 80/25; E01F 13/12; G05B 13/0265; B64U 2101/16

(57) ABSTRACT

The present disclosure relates to an unmanned aerial system designed to enhance public safety by addressing the dangers associated with high-speed vehicle pursuits. The system comprises a drone equipped with a modular payload and advanced vision software for tracking, intercepting, and disabling fleeing vehicles. The drone carries deployable spike strips capable of safely deflating tires to halt vehicles involved in pursuits. Upon deployment, the drone remains on-site to provide real-time surveillance and updates to law enforcement officers. The system includes charging bases that are ground or vehicle-mounted, allowing for extended operations. Additionally, the drone utilizes AI and machine learning models for object detection and threat analysis, automatically detecting and monitoring individuals exiting and fleeing from disabled vehicles. This technology aims to reduce fatalities and injuries resulting from high-speed chases by providing a safer and more efficient method for law enforcement intervention, adaptable for use in various regions and agencies worldwide.

### CROSS REFERENCE TO RELATED APPLICATIONS

This application claims the benefit of U.S. Provisional Application Ser. No. 63/599,348, entitled “Spike strip payload attached to UAS/drone which disables the tires of vehicles during a police chase and/or high speed pursuits” and which was filed on Nov. 15, 2023, the entirety of which is herein incorporated by reference.

### TECHNICAL FIELD

The present disclosure pertains to systems and methods for enhancing law enforcement and security operations through the autonomous and manual deployment of spike strips. The system also integrates Unmanned Aerial Systems (UAS) technology with artificial intelligence and machine learning models. These systems are designed to efficiently disable fleeing vehicles, enhance additional assets for entry control points (ECP), and are applicable for use by law enforcement agencies or security personnel in various high-risk pursuit and access control scenarios.

### BACKGROUND

High-speed pursuits represent a significant challenge in law enforcement operations, often leading to tragic and unintended consequences. Over the past four decades, more than 12,000 innocent individuals have lost their lives due to high-speed chases, with countless others sustaining injuries. These pursuits not only jeopardize public safety but also place law enforcement officers at considerable risk. In the course of manually deploying spike strips-a common method for disabling fleeing vehicles-officers are exposed to hazardous conditions. Statistics indicate that 26 officers were intentionally struck, resulting in five fatalities within a single year alone.

Furthermore, the necessity for officers to engage in dangerous high-speed pursuits to apprehend suspects exacerbates the risk of injury or death for both law enforcement personnel and the general public.

Traditional spike strip deployment methods are inherently risky and inefficient.

Manual deployment requires officers to physically place barriers in dynamic and often unpredictable environments, increasing their exposure to potential harm. The process is time-consuming and susceptible to human error, which can lead to inconsistent results and unsuccessful vehicle disabling during critical moments. Additionally, the reliance on manual intervention limits the scalability and responsiveness of law enforcement efforts, particularly in scenarios involving multiple or rapidly fleeing targets.

Existing systems for deploying spike strips lack the precision and reliability needed to effectively manage high-speed pursuits. The manual nature of these deployments not only heightens the danger to officers but also reduces the overall effectiveness of law enforcement operations. In dynamic pursuit situations, the inability to swiftly and accurately deploy spike strips can result in prolonged chases, escalating the risk of accidents, property damage, and loss of life.

Given these challenges, there is an urgent need for a safer, more efficient, and technologically advanced solution to manage high-speed pursuits. An ideal system would minimize the direct exposure of law enforcement officers to dangerous situations, enhance the precision and reliability of spike strip deployment, and provide real-time situational awareness to improve decision-making during pursuits. Such a system should leverage modern advancements in drone technology, artificial intelligence, and machine learning to autonomously track, intercept, and disable fleeing vehicles while maintaining robust surveillance capabilities.

The term “KHOPESH,” as referenced in this disclosure, is a project name and registered trademark associated with the invention, identified under U.S. Trademark Serial Number 98750574, with an application filing date of Sep. 13, 2024. This trademark is used solely for identification and branding purposes and does not confine or restrict the scope of the invention to any specific configuration, feature, or implementation suggested by the name. The term “KHOPESH” may refer to the machine learning model, the AI agent, the payload device, the components mounted on UAS platforms, or any combination or permutation of these configurations. Thus, the KHOPESH device and connected systems disclosed herein address the above discussed critical need by providing a safer approach to spike strip deployment. By integrating autonomous and manual deployment mechanisms with Unmanned Aerial Systems (UAS) and advanced machine learning models, KHOPESH aims to revolutionize law enforcement tactics in high-speed pursuit scenarios. This system not only enhances the safety and operational efficiency of law enforcement officers but also significantly reduces the risks associated with traditional pursuits to the general public.

### SUMMARY

Provided is an autonomous or manually deployable spike strip deployment system including: equipping a drone with a modular payload containing an artificial intelligence/machine learning (AI/ML) processing unit and a vision sensor array; enabling the drone to autonomously track and intercept fleeing vehicles during high-speed pursuits; deploying spike strips either automatically via the AI/ML model or manually through a user interface by releasing a separate payload containing detachable spikes; transmitting real-time situational data and updates to law enforcement officers; managing power and data connections through universal mounting brackets and connector interfaces; and monitoring deployment events and system performance through a secure portal. The system leverages AI-driven vision sensors to accurately identify and target vehicles, determine optimal deployment timing, and ensure precise activation of spike strips. Additionally, the system includes voice capabilities for interactive communication between the AI agent and law enforcement personnel, gathers metrics and insights to aid in operational decision-making, and provides on-scene surveillance to enhance situational awareness. The system also incorporates charging bases for drone recharging, protective enclosures for electronics, and manual control mechanisms to provide flexibility and redundancy. The reusable spikes are integrated into the dropped payload, ensuring effective vehicle disabling upon deployment. Furthermore, the system integrates with existing drone platforms to enhance operational efficiency and safety in law enforcement and security scenarios.

Provided also is an autonomous or manually deployable spike strip deployment system comprising: a drone platform equipped with a universal mounting interface; a modular payload containing a metal structural housing, AI/ML processing unit, vision sensor array, and power management components; a separate dropped payload containing a spike strip deployment mechanism and reusable spikes; a release mechanism transmitter and powered servo for controlling deployment and retraction of spike strips; and a central server for data processing and system management. The system is configured to receive real-time video feeds, process visual data using proprietary machine learning models to identify and classify target vehicles, execute deployment sequences based on predefined criteria by releasing the separate payload with reusable spikes, and provide real-time updates to operators. The AI/ML processing unit determines the precise moment and location for spike strip deployment, ensuring effective vehicle disabling while minimizing risk to human life. The system includes voice interaction capabilities, allowing the AI agent to communicate with officers and respond to verbal commands. It also gathers and analyzes metrics and insights to support law enforcement agencies in making informed operational decisions. Additionally, the system provides comprehensive on-scene surveillance, enhancing situational awareness and enabling proactive response to emerging threats. The system supports both autonomous and manually deployable modes, enhancing versatility and operational control in dynamic pursuit situations.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures.

It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1 is a general flowchart of the software's functions.

FIG. 2 shows a dimensionalized diagram of the KHOPESH mechanical device in the closed configuration.

FIG. 3 shows another dimensionalized diagram of the KHOPESH mechanical device in the closed configuration.

FIG. 4 shows another dimensionalized diagram of the KHOPESH mechanical device in the closed configuration.

FIG. 5 shows another dimensionalized diagram of the KHOPESH mechanical device in the closed configuration.

FIG. 6 shows a dimensionalized diagram of the KHOPESH mechanical device in the extended configuration with detachable spikes presenting at maximum height.

FIG. 7 shows another dimensionalized diagram of the KHOPESH mechanical device in the extended configuration with detachable spikes presenting at maximum height.

FIG. 8 shows another dimensionalized diagram of the KHOPESH mechanical device in the extended configuration with detachable spikes presenting at maximum height.

FIG. 9 shows another dimensionalized diagram of the KHOPESH mechanical device in the extended configuration with detachable spikes presenting at maximum height.

FIG. 10 shows a dimensionalized diagram of the KHOPESH mechanical device in the closed configuration with removable components hidden.

FIG. 11 shows another dimensionalized diagram of the KHOPESH mechanical device in the closed configuration with removable components hidden.

FIG. 12 shows another dimensionalized diagram of the KHOPESH mechanical device in the closed configuration with removable components hidden.

FIG. 13 shows another dimensionalized diagram of the KHOPESH mechanical device in the closed configuration with removable components hidden.

FIG. 14 shows a dimensionalized diagram of the KHOPESH mechanical device's interior, detailing the detachable spikes in the closed configuration. Further details magnetic spikes connections.

FIG. 15 shows another dimensionalized diagram of the KHOPESH mechanical device's interior, detailing the detachable spikes in the closed configuration. Further details magnetic spikes connections.

FIG. 16 shows another dimensionalized diagram of the KHOPESH mechanical device's interior, detailing the detachable spikes in the closed configuration. Further details magnetic spikes connections.

FIG. 17 shows another dimensionalized diagram of the KHOPESH mechanical device's interior, detailing the detachable spikes in the closed configuration. Further details magnetic spikes connections.

FIG. 18 shows another dimensionalized diagram of the KHOPESH mechanical device's interior, detailing the detachable spikes in the closed configuration. Further details magnetic spikes connections.

FIG. 19 shows a screenshot of a version of the KHOPESH AI/ML training software dashboard.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts. As described herein, the use of the term “and/or” is intended to represent an “inclusive OR”, and the use of the term “or” is intended to represent an “exclusive OR”.

The present disclosure pertains to systems and methods for deploying spike strips to disable vehicles, utilizing either drone-based or manual deployment mechanisms integrated with a proprietary Machine Learning (ML) model (e.g., the Khopesh system). Currently, law enforcement agencies manually deploy spike strips during high-speed pursuits, exposing officers to significant safety risks, including potential injuries or fatalities from direct confrontations with fleeing suspects.

Additionally, manual deployment is often inefficient and unreliable in dynamic pursuit scenarios, increasing the exposure and danger to officers and prolonging dangerous high-speed chases. Current methods often require law enforcement officers to physically place barriers in high-risk pursuits or use their own patrol vehicles, resulting in unnecessary damage to agency property. This “up close and personal” approach not only heightens the risk of injury or fatality for officers but also limits the scalability and responsiveness of pursuit operations. The reliance on human intervention can lead to delays in deployment, reduced precision in placement, and an increased likelihood of confrontations between officers and suspects. Collectively, these factors create a hazardous environment for law enforcement personnel and reduce the efficiency of managing pursuits.

The systems and methods of the present disclosure represent a substantial improvement over current technologies by addressing the significant dangers associated with high-speed pursuits through vehicle identification, tracking and deployment of spike strips using a ML model. High-speed pursuits have resulted in tragic outcomes, with over 12,000 innocent lives lost and countless injuries over the past 40 years. Project KHOPESH leverages drones equipped with modular payloads and advanced vision software to accurately track, intercept, and disable the tires of vehicles, thereby creating a larger safety zone for officers who can remain at a distance. Unlike traditional methods, the KHOPESH system utilizes drones to provide precise and reliable spike strip deployments, even in congested traffic. This approach reduces the exposure of law enforcement personnel to dangerous situations while driving through traffic on the road and enhances the precision and reliability of spike strip deployments, contributing to safer and more efficient management of high-speed pursuits.

In one aspect of the present disclosure, the KHOPESH platform provides an integrated control interface, enabling operators to manage, assign, and deploy spike strip missions for law enforcement and public safety applications. This platform also facilitates data-driven insights by analyzing and cataloging various pursuit scenarios, including vehicle types, engagement success rates, and operational parameters.

Operators and law enforcement agencies can utilize this platform to configure deployment parameters, review mission outcomes, and access training modules that enhance operational readiness.

In another aspect of the present disclosure, the KHOPESH system's onboard software suite processes visual and environmental data collected from drone-mounted sensors, including speed, trajectory, and road conditions, to calculate optimal deployment moments. The software employs a secure communication protocol to transmit real-time updates to a central command dashboard, which law enforcement can use to monitor deployment status and drone position. Additionally, the system's ML algorithms continuously refine vehicle identification and targeting models, adapting to new patterns and data from real-world deployments.

The objective of the present disclosure is to provide real-time vehicle tracking and disabling capabilities for law enforcement without requiring significant modifications to existing operational platforms. A law enforcement user initiates a command to the KHOPESH platform, sending vehicle identifiers and unique deployment parameters to the system. The software then issues the necessary commands to the drone's navigation and payload systems, which initiates a sequence of automated actions as the drone autonomously tracks and intercepts the target vehicle. Before executing the final deployment of the spike strip, the system verifies that all parameters for an effective deployment are met, ensuring accurate, safe, and controlled vehicle disabling in real-world pursuit scenarios.

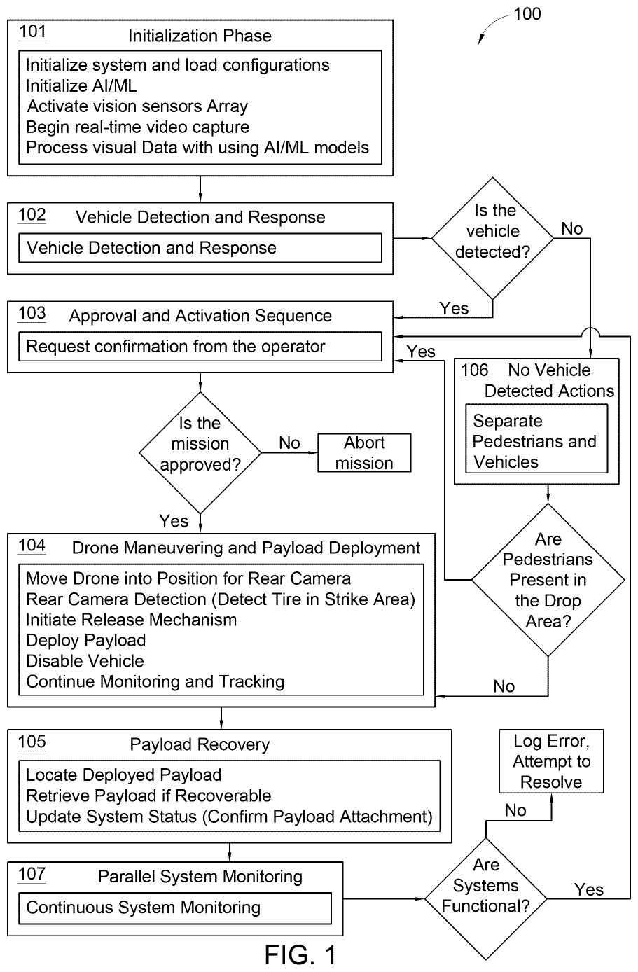

FIG. 1 is a flowchart representation of the primary operational method of the software provided by the present disclosure, illustrating how the Khopesh system autonomously collects vehicle and environmental data, processes it in a sequence of programmed steps, and then passes deployment commands to the drone's navigation and spike strip mechanisms for targeted vehicle interception and disabling.

Specifically, FIG. 1 relates to a process 100 to use the Khopesh system's software, which enables autonomous vehicle tracking and spike strip deployment in high-speed pursuits without requiring law enforcement to manually deploy or control the system at close range. This automation allows for effective vehicle disabling in real time, minimizing the need for direct officer intervention and increasing operational safety. The flowchart illustrates the primary program sequence, where the system autonomously collects vehicle and environmental data, processes it to determine optimal deployment timing, and transmits commands to the drone's navigation and deployment mechanisms. The software includes the components described in the following sections. Also, the order of the following steps is an example but is not limited to the exact order that is described below, and various steps can appear in different order.

To initiate a mission in the process 100, the user sends a request to the Khopesh using the chat or voice functions, specifying attributes like vehicle make, model, color, and license plate information. This process, referred to as the ‘Locate’ protocol, enables the system to autonomously collect all relevant environmental data and vehicle identifiers, displaying the vehicle of interest clearly and planning routes to intercept.

Once the vehicle is confirmed, the drone maintains a flight path to intercept and requests a final confirmation from the operator before initiating further protocols. Initialization Phase 101: The Initialization Phase 101 encompasses the initial setup and configuration procedures necessary for the software to commence operation. This phase involves system checks, loading of essential parameters, and establishing baseline conditions to ensure that subsequent processes operate within defined parameters. The Initialization Phase sets the groundwork for reliable and efficient performance of the software system. Vehicle Detection and Response 102: the Vehicle Detection and Response step 102 refers to the system's capability to identify the presence of vehicles within a specified area using advanced sensor technologies. Upon detection, the system processes the data to determine appropriate responses, which may include alert generation, tracking, and initiating subsequent actions based on predefined criteria. This component is critical for the system's ability to interact dynamically with moving objects in its environment. Approval and Activation Sequence 103: The Approval and Activation Sequence 103 outlines the procedural steps required for validating and enabling system operations. This includes user authentication, authorization checks, and confirmation protocols to ensure that only authorized personnel can activate or modify system functionalities. This sequence safeguards the system against unauthorized access and ensures that all activations are deliberate and verified. Drone Maneuvering and Payload Deployment 104: the Drone Maneuvering and Payload Deployment step 104 describes the controlled navigation of the drone to designated locations and the precise release of payloads. This process utilizes real-time data and control algorithms to adjust the drone's flight path, altitude, and speed, ensuring accurate payload delivery. The deployment mechanism is designed to handle various payload types and conditions, maintaining operational integrity during execution. Payload Recovery 105: the Payload Recovery step 105 involves the retrieval of deployed payloads post-mission. This process may include autonomous navigation back to the payload location, utilization of recovery mechanisms such as nets, hooks, or magnets, and secure transportation of the payload to a designated collection point. Efficient payload recovery ensures reusability and minimizes loss or damage to the payload devices. No Vehicle Detected Actions 106: the No Vehicle Detected Actions step 106 defines the system's response when no vehicles are identified within the monitoring area. In such scenarios, the system may enter a standby mode, perform routine diagnostics, or engage alternative operational protocols. These actions ensure optimal resource utilization and maintain system readiness for future detections. Parallel System Monitoring 107: the Parallel System Monitoring step 107 entails the simultaneous oversight of multiple system components and processes to ensure cohesive and uninterrupted operation. This includes real-time tracking of system health, performance metrics, and environmental conditions. Parallel monitoring enhances system reliability by enabling prompt detection and resolution of anomalies or failures.

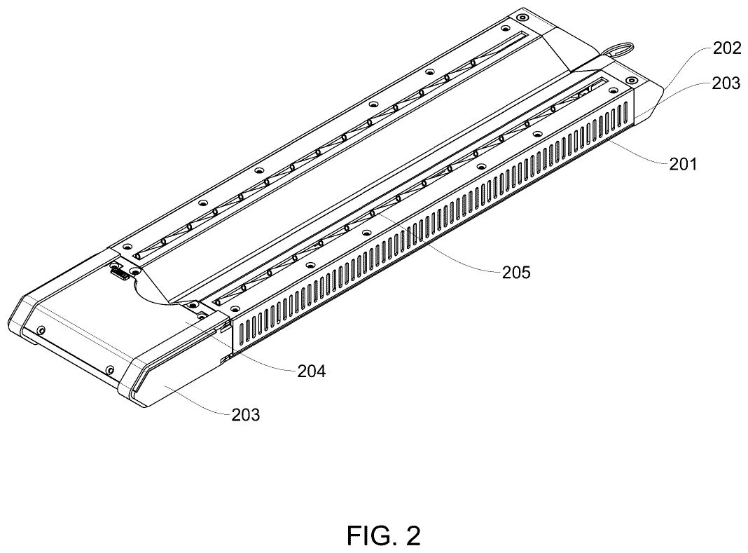

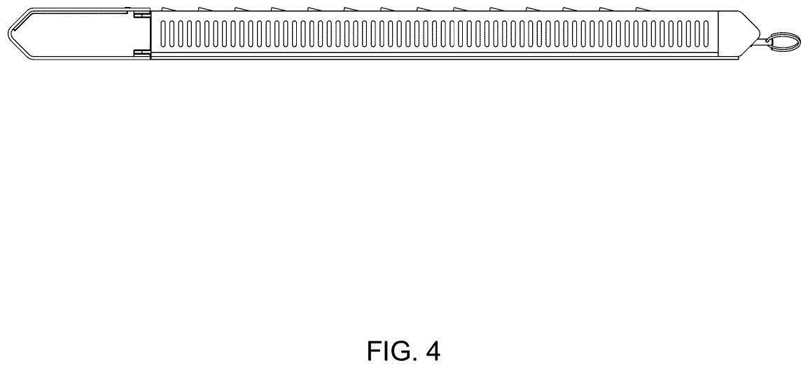

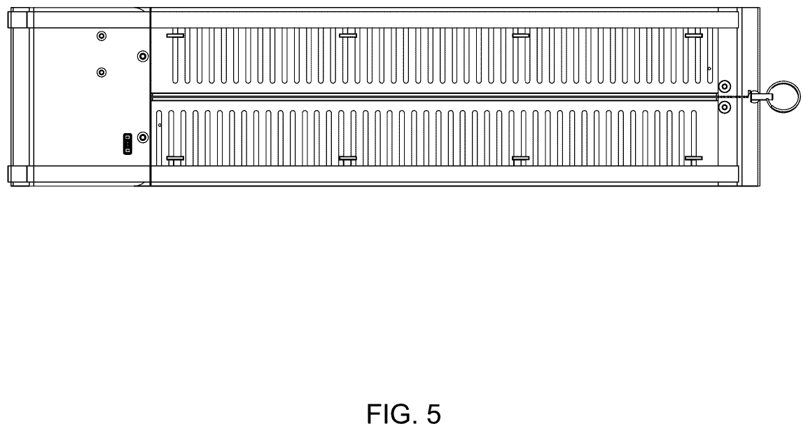

FIGS. 2-5 show a diagram of the KHOPESH device in its closed configuration. The illustration details connections to the primary module through magnetic connections, allowing for rapid attachment and detachment while maintaining a secure hold. This magnetic interface links the payload to a base module housing the vision sensor array and remains affixed to the drone through a variety of universalized connectors. This is done in an effort to facilitate a straightforward mounting and detachment process without the need for mechanical latches or tools. The payload's structure includes rubber strips on the cap, designed to absorb impact upon deployment from the unmanned aerial system (UAS). These strips reduce the potential for damage when the payload is released or repositioned during operations, contributing to its durability during field use. Inside its semi-closed housing, the cap piece secures sensitive equipment during impact, shields it from dust, moisture, and other environmental factors. An integrated locking mechanism keeps all components secure during transit and is designed to release only when necessary. This closed configuration is built for aerodynamic efficiency, maintaining the drone's balance and profile while holding the payload ready for rapid deployment in a variety of environments. Now, all the components in FIGS. 2-5 will be described.

Payload in Closed State 200: This is the payload device in a closed state 200, as described above. Metal Housing 201: the metal housing 201 comprises a robust enclosure fabricated from high-strength materials such as aluminum or titanium. It serves as the primary protective casing for the payload device 200, safeguarding internal components from environmental factors and mechanical stresses. The metal housing 201 is engineered to withstand impact forces and corrosion, ensuring longevity and durability in diverse operational conditions. End Cap 202: The end cap 202 is affixed to the extremities of the metal housing 201, providing structural integrity and sealing the enclosure. It features precision-engineered fittings to ensure airtight and watertight closures, preventing ingress of debris and moisture. The end cap 202 also facilitates secure attachment points for mounting additional components or accessories as required. Magnetic Plates 203: the magnetic plates 203 are integrated into the interior surfaces of the metal housing 201, enabling secure attachment and alignment of detachable components. These magnetic plates 203 utilize strong magnetic fields to maintain positional stability, allowing for quick assembly and disassembly of payload elements (e.g., payload device 200) without compromising structural security. The magnetic plates 203 enhance modularity and ease of maintenance. Nose Cap 204: the nose cap 204 is positioned at the front end of the payload device 200, serving as a protective barrier and aerodynamic interface. It is designed to accommodate sensor arrays or communication modules, providing unobstructed access for data transmission and reception. The nose cap 204 also contributes to the overall balance and flight dynamics of the payload device 200.

Detachable Spikes 205: the detachable spikes 205 are protruding elements incorporated into the payload device 200, intended for physical interaction with target surfaces or objects. These spikes can be securely attached or removed as needed, allowing for versatile application scenarios. The detachable nature of the spikes facilitates customization based on mission-specific requirements. Rubber Strips 206: the rubber strips 206 are applied to critical contact points within the payload device 200 to absorb impact forces and reduce wear and tear during operation. These elastomeric elements provide cushioning and enhance the durability of moving parts, minimizing the risk of damage from vibrations or collisions. The rubber strips 206 contribute to the overall resilience and longevity of the payload device.

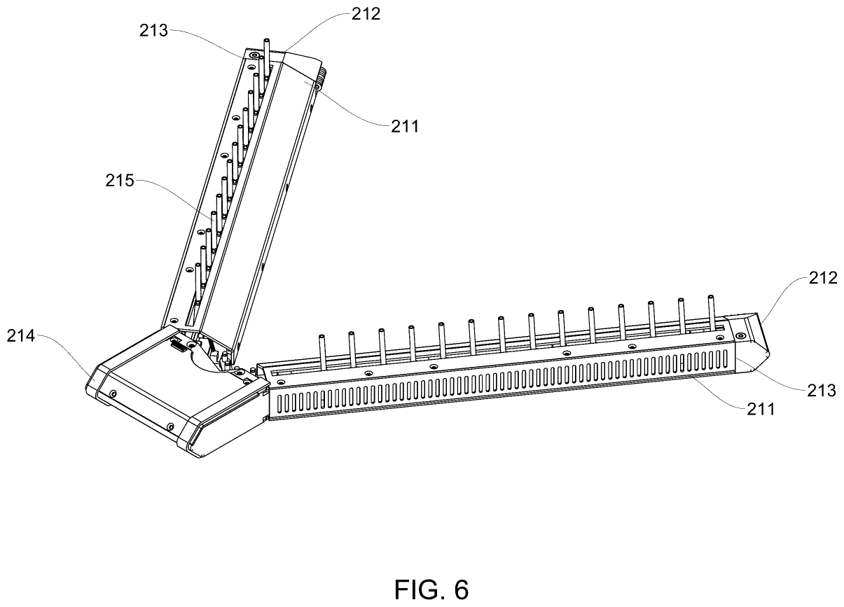

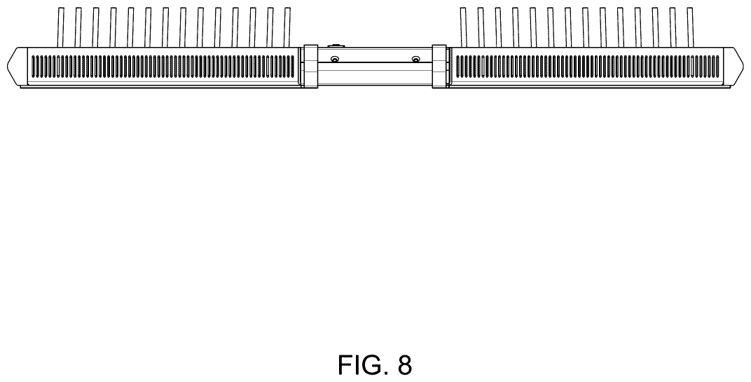

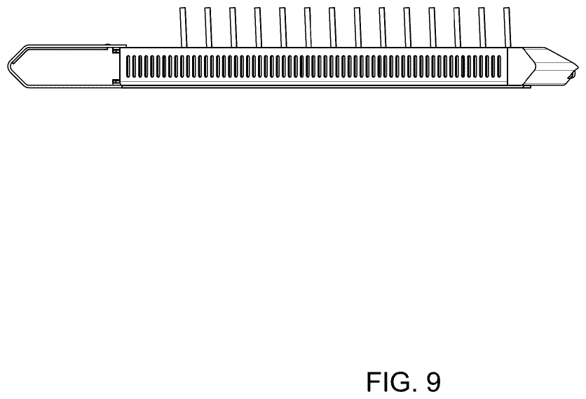

FIGS. 6-9 highlight that the device could be equipped or built with different shaped interior walls on the pieces that extend depending on the operational environment. This is to enable the payload to adapt to different terrains or surfaces as required. This modular leg structure ensures stability across various deployment conditions, supporting a range of mission scenarios. Reservations are made to incorporate functionality that would allow legs to pivot or tilt independently with motorized control when needed. Now, all the components in FIGS. 6-9 will be described. Payload Device in Open State 210: this is the payload device in an open state 210.

Metal Housing Made of Titanium or Aluminum 211: The metal housing in the open position 211 is constructed from lightweight yet strong materials such as titanium or aluminum, offering enhanced structural support while minimizing weight. This housing design accommodates the expansion and deployment of internal components, ensuring seamless transition between closed and open states. The choice of materials ensures optimal performance under varying environmental conditions. End Caps 212: The endcaps in the open position 212 maintain their role in sealing the metal housing while allowing for the expansion of internal mechanisms. They are engineered with adjustable fittings to accommodate the dynamic configuration changes required during the opening process. The end caps in the open position 212 ensure that the payload device remains secure and protected even in the deployed state. Magnetic Plates 213: The magnetic plates in the open position 213 retain their functionality in the open position, facilitating the secure attachment of additional modules or components during deployment. Their persistent magnetic properties ensure that the payload device in the open position 210 maintains structural integrity and alignment, even as it transitions between different operational states. Magnetic plates in the open position 213 support the modularity and adaptability of the payload device. Nose Cap Holding the Proprietary PCB 214: The nose cap in the open position 214 houses the proprietary printed circuit board (PCB), integrating essential electronic components required for device operation. This configuration ensures that the PCB remains protected while allowing for effective cooling and accessibility for maintenance or upgrades. The placement within the nose cap optimizes signal transmission and minimizes interference. Detachable Spikes 215: the detachable spikes in the open position 215 extend outward from the payload device in the open position 210, ready for deployment or interaction with target surfaces. The mechanism for spike deployment is controlled electronically, ensuring precise timing and placement. The detachable spikes in the open position 215 maintain their secure attachment through reinforced connectors, allowing for reliable performance during mission-critical operations. Rubber Strips to Reduce Wear and Tear on Impact in the Open Position 216: the rubber strips in the open position 216 continue to provide impact absorption and protection for moving parts exposed during deployment. These strips in the open position 216 are strategically placed to minimize friction and wear during interactions with external surfaces, enhancing the durability and reliability of the payload device in the open position 210. The rubber strips in the open position 216 contribute to the smooth operation and longevity of the device in dynamic environments.

This disclosure intends to include that the KHOPESH payload device transitions from, as just an illustrative but not limiting example, a compact length of approximately 6 inches to a fully extended length of 35.5 inches in less than a second, utilizing a mechanism that integrates springs, pinions, and a servo system. This deployment system is designed to enable rapid and reliable extension, allowing the payload to quickly deploy in a variety of operational environments. The transition begins with a proprietary PCB sending the signal to fire preloaded springs, which store the necessary energy to drive the rapid extension. Once activated, these springs propel the components outward, while pinions guide and stabilize the deployment process, ensuring smooth and controlled motion. This enables the device to maintain alignment and structural stability as the system extends to its full length. Following the extension, the servo system is engaged to handle retraction or repositioning as needed, providing controlled motion to reset or adjust the payload for subsequent uses. This combination of components ensures that the system is capable of repeated cycles with consistent performance. Additionally, rubber strips on the cap are integrated to absorb impact forces during deployment, reducing stress on the payload and drone and minimizing potential damage. This robust yet efficient mechanism balances the speed of spring-driven deployment with the precision and control offered by the servo system, creating a dynamic and adaptable solution suited for various operational scenarios.

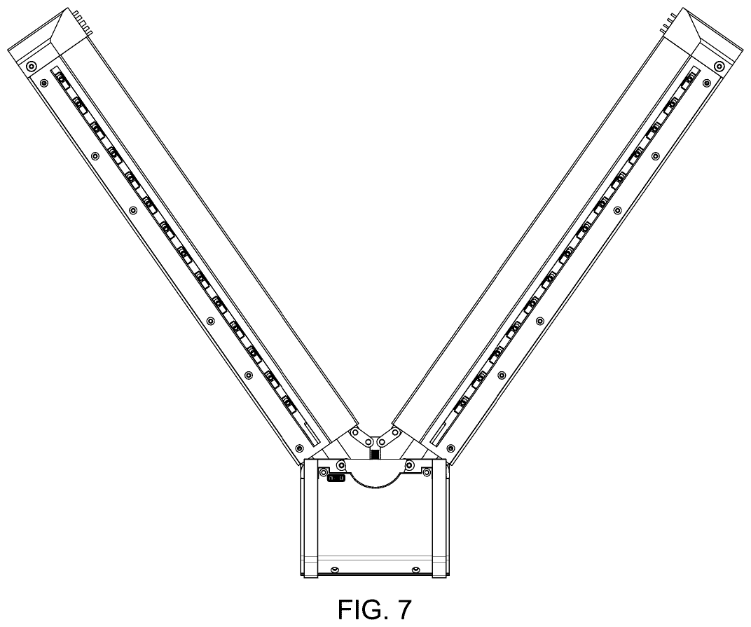

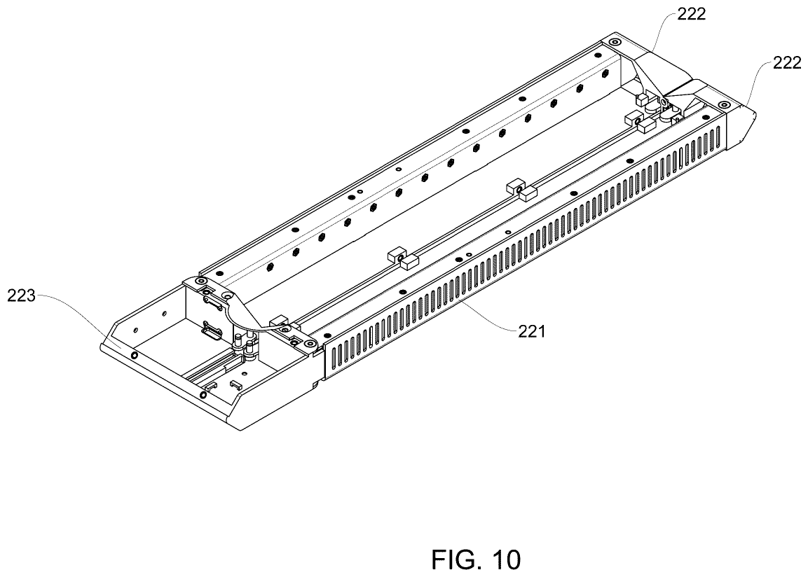

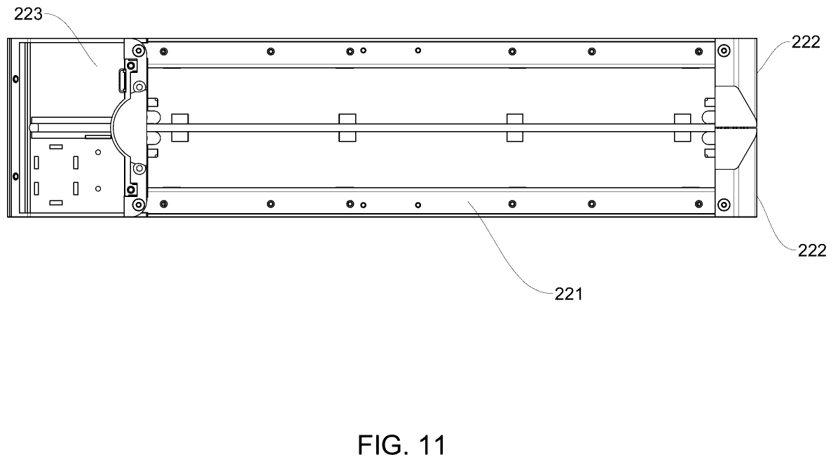

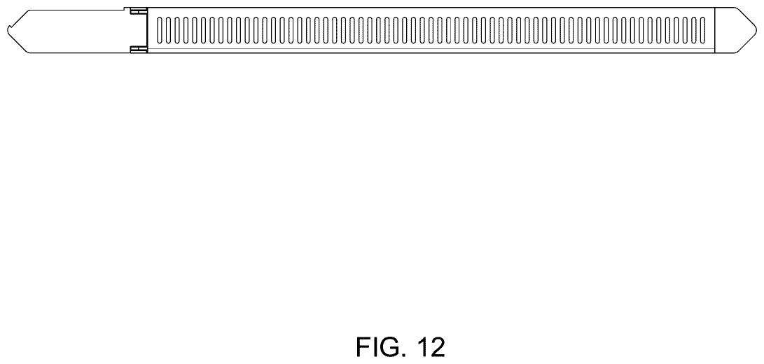

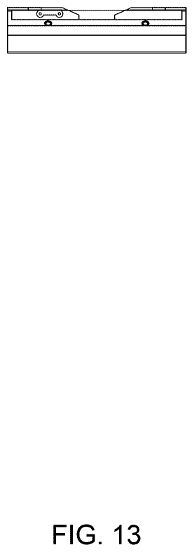

FIGS. 7-13 show the KHOPESH payload device depicted with all removable components hidden, highlighting the structural choices and customizable features of the core unit. The payload can be constructed with either aluminum or titanium, depending on the desired balance between cost and durability. Aluminum versions provide a cost-effective option suitable for standard operations, while titanium offers enhanced longevity and resilience, especially in challenging environments or for units expected to withstand significant wear and tear. The interior wall angles and slope of the payload are customizable to adapt to various terrains. For instance, a gentler slope can allow vehicles to drive over the payload effectively, making it ideal for deployment on paved or solid ground. In contrast, more squared angles may be advantageous in sandy, swampy, snowy, or other unstable terrains, where a firmer grip and stability are essential to keep the payload stationary. To prioritize safety, the battery storage is located in the nose caps or tail end caps, reducing the risk of damage to power components during impacts. This placement ensures that the batteries remain in the most protected position within the payload, mitigating impact forces and enhancing overall durability in field applications.

These design choices collectively support a versatile and resilient payload suitable for varied operational needs. Now, all the components in FIGS. 7-13 will be described. FIGS. 7-13 show the payload device with its components hidden 220. Frame or Metal Housing 221: the frame or metal housing in the hidden components configuration 221 serves as the foundational structure of the payload device in a hidden configuration 220. The housing in the hidden components configuration 221 is meticulously designed to conceal internal mechanisms while providing structural support and protection. The frame 221 integrates seamlessly with the overall design, ensuring that hidden components remain secure and inaccessible to unauthorized access. End cap 222: the end caps in this hidden configuration 222 are designed to blend with the frame, maintaining the aesthetic and functional integrity of the hidden components. They provide essential sealing and protection for the concealed interior, ensuring that the hidden components remain shielded from external elements. The end caps in the hidden configuration 222 also facilitate the integration of hidden access points for maintenance and upgrades. Nose Caps 223: the nose caps in the hidden components setup 223 are engineered to obscure the visibility of internal electronic and mechanical elements. They feature discreet designs that maintain aerodynamic efficiency while providing access for necessary connections and interfaces. The nose caps in the hidden configuration 223 ensure that the hidden components remain protected and operational without compromising the device's external appearance.

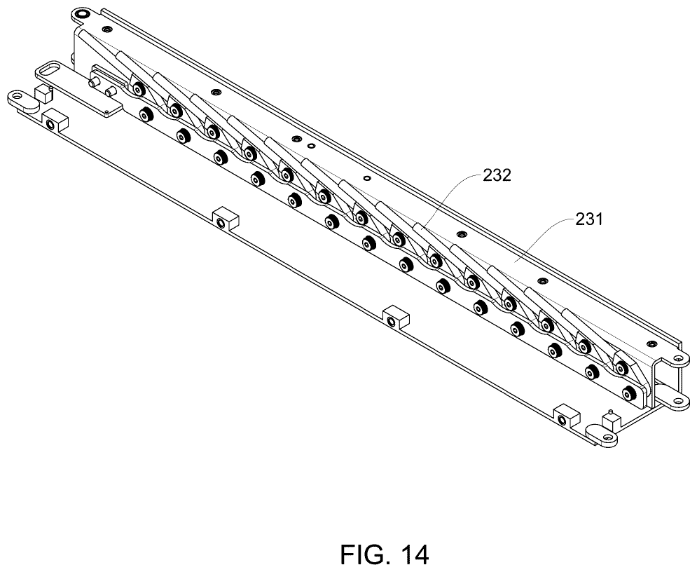

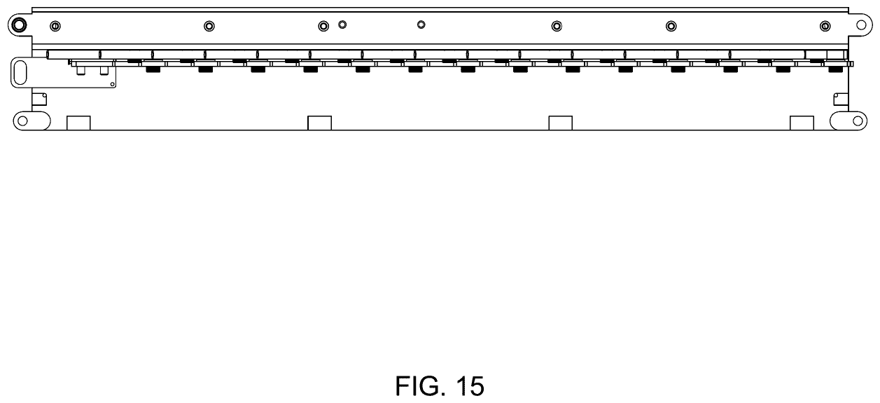

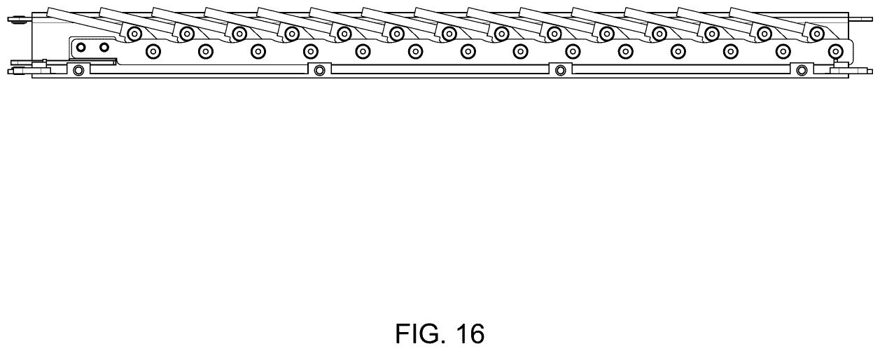

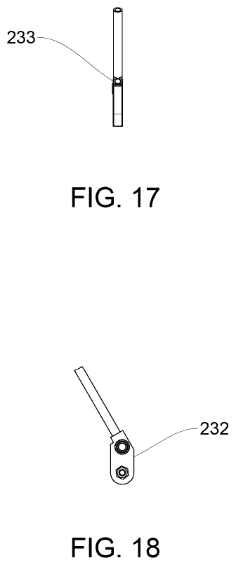

FIGS. 14-18 shows the steel hollow detachable spikes integrated into the Khopesh drone payload, which are designed to provide a controlled method of deflating vehicle tires. This is essential for tactical and law enforcement operations where gradual, safe deceleration is critical. These spikes puncture tires in a way that allows air to escape slowly and in a regulated manner, reducing the risk of sudden blowouts and enhancing the vehicle's controllability. Made from high-grade steel, each spike is both durable and hollow, engineered to create an airflow channel that ensures a controlled release of air upon tire penetration. This slow deflation minimizes risks associated with abrupt tire failure, enhancing safety for both bystanders, the driver, and law enforcement personnel. The hollow core of each spike also reduces weight, making it easier for the payload's magnetic attachment system to hold the spikes securely in place until deployment and maximizing drone flight time. The magnetic mechanism is crucial to the spike system's functionality, as each spike has a magnetic base that attaches to the payload. This secure connection prevents accidental detachment and ensures the spikes only release upon direct contact with a vehicle tire capable of picking it up. When a tire rolls over a spike, the pressure breaks the magnetic hold, allowing the spike to detach and embed into the tire, where it is then carried along as the vehicle moves. This design ensures the controlled deflation process continues while minimizing the chance of spikes remaining scattered on the ground. By sticking to the tire, each spike remains active until the tire fully deflates, enhancing operational safety by preventing loose spikes from damaging other vehicles. The magnetic attachment is specifically designed to withstand environmental vibrations and shifts, keeping the spikes secure during drone operation. Another critical safety feature of the spike system is its retraction capability, controlled by a servo that can retract the payload in a few seconds. This allows all spikes to withdraw quickly into a secure position, preventing any potential hazard to bystanders when the payload is inactive, being transported, or repositioned. This quick retraction mechanism is essential for situations that require immediate de-escalation, as it allows the payload to be rendered safe almost instantly. This feature supports tactical flexibility, allowing operatives to retract the spikes when not needed and redeploy as the situation demands. The combined features of controlled deflation, magnetic attachment, and fast retraction provide a balance of operational efficiency and safety, making the spike system suitable for complex, high-stakes situations where a low-profile device that will deploy reliably is required. Now all the components of FIGS. 14-18 will be described. The interior of the payload device 230 is shown in FIGS. 14-18. The payload device interior 230 encompasses the internal configuration and arrangement of components within the payload device. This area is meticulously organized to facilitate efficient operation, maintenance, and scalability of the payload functionalities. The interior design ensures optimal utilization of space, thermal management, and protection of sensitive components from environmental and operational stresses. Metal Housing 231: The metal housing 231 within the payload interior 230 provides a secure and protective environment for all internal components. Constructed from high-strength materials, it safeguards electronic circuits, sensors, and mechanical parts from physical damage, moisture, and electromagnetic interference. The housing 231 design incorporates ventilation and cooling pathways to maintain optimal operating temperatures for all enclosed systems. Detachable Spikes 232: the detachable spikes 232 housed within the payload interior 230 are maintained in a retracted position, secured by locking mechanisms to prevent accidental deployment. These spikes 232 are designed for rapid deployment upon receiving the appropriate activation signal, ensuring readiness for immediate use. The internal storage of spikes 232 maximizes the payload's aerodynamic profile and minimizes space utilization. Magnet that Holds the Spike in Place Until Sufficient Force is Applied to Pull It Up 233: A specialized magnet 233 is integrated into the payload interior to securely hold the detachable spikes in their retracted position. This magnet 233 exerts a precise force that maintains spike stability during transit and normal operations. Upon application of sufficient external force, the magnetic hold is overcome, allowing the spikes to be deployed swiftly and reliably. This mechanism ensures both the security and responsiveness of the spike deployment system.

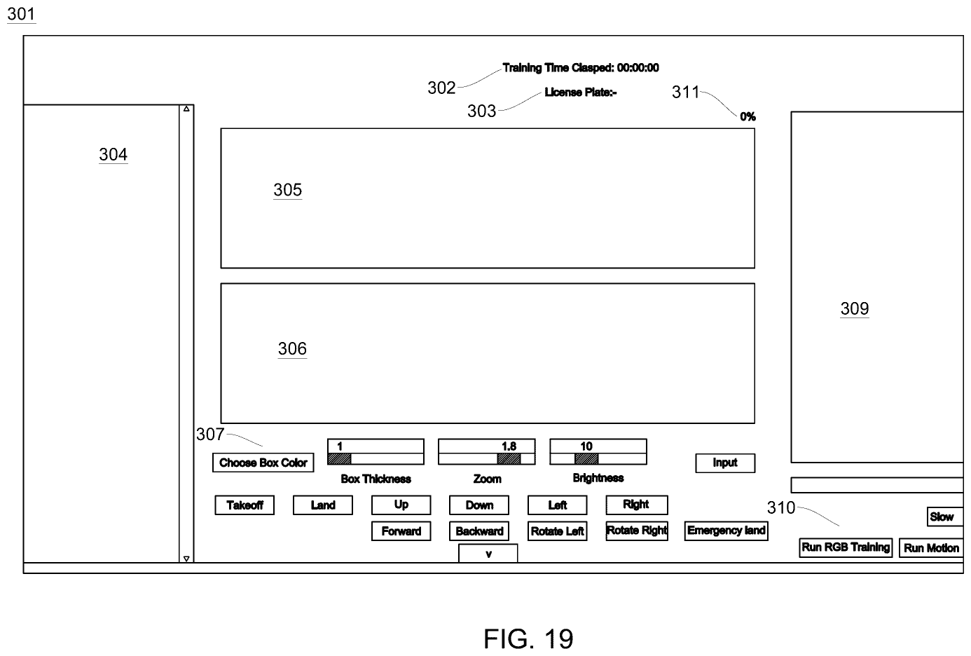

FIG. 19 shows KHOPESH's model training software, which provides a control system for testing drone connection, navigation, camera adjustments, and training of machine learning models. The layout features a dark background with clearly labeled controls for easy access during operation. At the top of the screen, there is a “Training Time Elapsed” display to track the duration of the current training session. Adjacent to this is a field labeled “License Plate,” which displays the license plate of the most recent vehicle of interest. The main interface is divided into several sections. On the left, there is a large vertical panel with a scroll bar, used for curating images for the model's classification training. This layout allows operators to select and organize images that will be used for supervised learning tasks or to enhance the model's recognition capabilities. The center of the interface includes two video feed displays, positioned one above the other. The top display shows an RGB video feed that overlays bounding boxes with labels predicting nearby vehicles'make, model, color, year, and distance from the drone. This feed is also aware of pedestrians in the area, providing safety information to avoid unintended interactions. The bottom display shows motion imaging, which supports model training in low-light conditions by focusing on movement and distinguishing objects based on motion rather than color or fine details. The right side of the interface is KHOPESH's chat window, where all dialogues and communications with the AI agent are conducted. This window allows operators to issue commands directly to KHOPESH and query vehicles for training purposes. Through this chat interface, users can interact with the AI to adjust parameters, request information about specific vehicles, or issue commands to refine the model's capabilities, making it a central hub for interaction with the AI agent. Below the video displays, a set of control buttons and sliders manage drone operations. The buttons allow for directional movement with controls like “Up,” “Down,” “Left,” “Right,” “Forward,” and “Backward.” There are rotation controls labeled “Rotate Left” and “Rotate Right,” as well as specific action buttons for “Takeoff,” “Land,” and “Emergency Land.” Additional controls include sliders for adjusting “Zoom,” “Brightness,” and “Exposure,” each marked with numerical values to fine-tune camera settings for various conditions. A “Choose Box Color” button likely customizes bounding box colors in the video feeds, potentially aiding in distinguishing different types of detected objects. An “Input” button toggles between video inputs. At the bottom of the interface, there are buttons related to model training, including “Run RGB Training,” “Run Motion Training,” “Stop Training,” and “Reset Model.” These options allow operators to initiate different training modes-specifically, RGB for color-based object detection and Motion for movement-based recognition-to improve model performance under varied lighting conditions. A “Show Debug Panel” button is used by developers for accessing detailed logs or debugging information. At the bottom-center, there is a branding logo labeled “ATMOS Research & Development.”

The overall organization of controls and displays in KHOPESH's model training software enables operators to manage essential drone and camera functions, interact directly with the AI agent through the chat window, and initiate model training tasks without unnecessary complexity, focusing on real-time drone surveillance and detection tasks. Now the components in FIG. 19 will be described in detail. Machine Learning Training Software process 300 will be described. The Machine Learning Training Software 300 constitutes the core computational framework responsible for developing and refining the artificial intelligence models utilized within the system. This software integrates various algorithms, data processing modules, and optimization techniques to facilitate the training of models on extensive datasets. It ensures the scalability, accuracy, and efficiency of the training processes, thereby enhancing the overall performance and reliability of the intelligent system. Training Status Bar 301: the Training Status Bar 301 provides a real-time visual indicator of the progress of the model training process. It displays the current state of training, including percentage completion. This feature enables users to monitor the advancement of training activities, ensuring transparency and facilitating timely interventions if necessary. Training Time Elapsed 302: the Training Time Elapsed 302 feature tracks the duration of the model training process from initiation to completion. It records the total time consumed in training the models, providing valuable metrics for assessing training efficiency and performance. This information aids in optimizing training schedules and resource allocation for future model development endeavors. Last License Plate Detected 303: the Last License Plate Detected 303 displays the most recent license plate information of a vehicle of interest identified by the software during high-risk situations. This feature retains the last detected license plate data, allowing operators to reference and analyze specific incidents. It enhances situational awareness and supports investigative activities by providing a record of relevant vehicle identifications. Image Classification Curator Panel 304: the Image Classification Curator Panel 304 allows users, primarily developers, to manage the training dataset by deleting selected images. This functionality facilitates the fine-tuning of the dataset, ensuring that only relevant and high-quality images are utilized in the model training process. By enabling precise control over the dataset composition, this panel enhances the accuracy and effectiveness of the trained models. RGB Feed 305: the RGB Feed 305 provides the operator with real-time visual data from the camera feed, augmented with bounding boxes that highlight predictions and issue warnings related to civilian considerations. This feature delivers immediate and actionable visual information, aiding operators in making informed decisions based on the system's real-time analysis and detections. Background Subtraction Video Feed 306: the Background Subtraction Video Feed 306 exclusively displays moving objects within the camera's field of view, thereby aiding the model's performance in low-light conditions. By isolating dynamic elements from the static background, this feed enhances the model's ability to detect and track objects of interest, even in challenging lighting environments. Video Control Panel 307: the Video Control Panel 307 enables users to adjust various camera view features, including zoom levels, exposure settings, and bounding box thickness. This interface provides granular control over the visual output, allowing users to tailor the camera feed to specific operational requirements and optimize the visibility of detected objects. Flight Control Panel 308: the Flight Control Panel 308 encompasses all necessary controls for manual drone flight operations. It includes interfaces for maneuvering the drone, adjusting flight parameters, and executing navigational commands. This panel ensures that operators have comprehensive control over the drone's movement and behavior during manual flight scenarios. KHOPESH Chat Feature 309: The KHOPESH Chat Feature 309 enables users to interact directly with the AI agent through a conversational interface. This functionality allows for real-time communication, query resolution, and command execution, enhancing user engagement and facilitating seamless interaction with the intelligent system. Model Training Control Panel 310: the Model Training Control Panel provides 310 users with the ability to manage the training processes of the machine learning models. It includes controls for initiating, pausing, stopping, and resetting model training sessions. This panel offers users comprehensive oversight and control over the training lifecycle, ensuring that training activities can be efficiently managed and adjusted as needed. Drone Battery Remaining 311: the Drone Battery Remaining indicator 311 displays the current battery level of the drone, providing real-time information on remaining power reserves. This feature enables operators to monitor the drone's operational capacity, plan missions accordingly, and ensure timely recharging or battery replacement to maintain uninterrupted drone functionality. Toggle Debug Panel 312: the Toggle Debug Panel 312 allows developers to access detailed insights into the program's operational status and performance. By enabling this panel, developers can monitor system metrics, track execution flows, and identify potential issues. This functionality is essential for troubleshooting, optimizing performance, and implementing updates effectively.

According to an aspect of the present disclosure, KHOPESH's payload device may be used through two primary methods, which can occur in sequence or independently. In the first method, a manual deployment process is provided, where the operator initiates the release by activating a manual release mechanism. In this scenario, the operator can simply throw the device, which deploys automatically upon impact with the ground, extending to its full operational state. Alternatively, the operator may place the device on the ground without engaging the manual release. Once positioned, the device can be deployed remotely via a transmitter, allowing the operator to activate it from a safe distance when needed.

In another deployment context, KHOPESH is used as part of drone-mounted operations for law enforcement during high-risk or high-speed pursuits. In such situations, a report of a vehicle of interest prompts the system to initiate, with the model beginning to train on relevant data associated with the target vehicle (such as make, model, color, and license plate information). As the law enforcement officer (LEO) patrol car approaches the vicinity of the vehicle of interest, the drone deploys and scans the traffic ahead, searching for the target vehicle.

Upon locating a vehicle that matches the target's general description, KHOPESH's drone system attempts to confirm the vehicle's identity by scanning for the license plate number. Once the drone has confirmed the vehicle's make, model, color, and license plate, it prompts the operator for confirmation to proceed with an interception. If the operator declines, the drone continues scanning other vehicles in the area, remaining available for further commands or manual redirection to another area of interest. If the operator approves, the drone begins closing the distance to the target vehicle, positioning itself such that it can eventually switch to its rear camera view with the vehicle directly behind it.

Before the deployment, the system requests a final confirmation from the operator. Once approved, KHOPESH sends an electrical signal to activate the release mechanism. This mechanism drops the payload nose-first into the ground in front of the target vehicle's tire. Upon impact, the device rapidly extends to full deployment within a second, disrupting the tire's function and disabling the vehicle's ability to continue moving. This allows law enforcement to safely intervene and neutralize the situation.

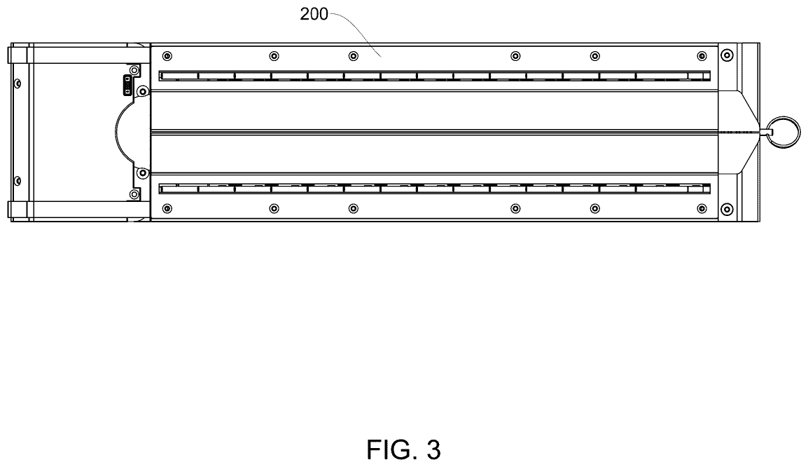

FIG. 3.'s disclosure is directed to show a computer software system that enables law enforcement agencies and drone operators to track and manage vehicle interceptions occurring as a result of drone deployments initiated during high-risk or high-speed pursuits, without requiring separate configurations for each deployment scenario or updates to mission control protocols. This software operates as an integrated service with a method that processes all relevant operational and vehicle data available to the system operator. The system is designed to collect and organize device and environmental data, including the drone's GPS location, camera feed, and telemetry data, ensuring accurate and real-time information flow to the backend server. Using a secure API, the software transmits mission commands, vehicle identifiers, and operational parameters between the operator interface, the drone, and the central command system. A validation and transmission layer ensures that all necessary data-such as the target vehicle's make, model, color, license plate, and operator confirmations-are verified before deployment actions are executed. This data is displayed in a user-friendly dashboard, which allows operators to monitor mission details, adjust drone operations, and issue commands such as confirm interception, adjust scanning area, or deploy the payload.

In one aspect of this disclosure, the software control interface is not limited to traditional computer interfaces and could extend to deployment using Augmented Reality and/or Virtual Reality.

In one aspect of the present disclosure, provided is a computer-implemented method that includes deploying drones equipped with KHOPESH's tracking and interception software, designed with helium integration to offset weight and extend flight duration. This method involves a drone system with a magnetic quick-connection within its base station, allowing for efficient recharging of helium to offset any loss over time. The drone base station, modularly built, contains small, replaceable helium cartridges that automatically connect to the drone upon landing. When a drone with low or depleted helium levels returns to the base, the magnetic quick-connection mechanism enables the helium cartridges to recharge the drone's helium supply swiftly and seamlessly, optimizing the drone's operational time and maintaining lightweight stability for extended missions. This approach ensures that drones can be deployed with consistent flight performance without manual helium refilling, supporting longer and more effective tracking and interception operations.

In one aspect of the present disclosure, provided is a method that includes deploying drones equipped with a magnetic quick-connect charging system within the drone's base station. This base station, modularly built, includes a magnetic quick-connect charging cable that automatically attaches to the drone upon landing, providing a rapid recharge to drones with low or depleted battery levels. When the drone returns to the base, the magnetic connection enables the charging process to begin immediately, minimizing downtime between deployments. This design ensures efficient energy replenishment without manual intervention, allowing drones to be swiftly prepared for extended tracking and interception operations, maintaining optimal power levels to support consistent mission performance.

In another aspect of the present disclosure, provided is a proprietary PCB and custom firmware placed into the nose cap of the KHOPESH payload device. This PCB is designed to manage core operational functions, including controlling the servo for precise deployment actions. The PCB is equipped with GPS for location tracking and an Inertial Measurement Unit (IMU) to monitor orientation and movement, ensuring accurate positioning during and after deployment. To increase reliability, a redundant backup PCB is incorporated, ready to take over in case of primary system failure. This redundancy ensures uninterrupted operation, critical for high-stakes missions, and maximizes the payload's effectiveness in austere operational environments.

In one aspect of the present disclosure, KHOPESH includes custom voice accessibility options and adjustable reporting features to enhance operational awareness and accessibility. The system is equipped with voice alerts that can provide real-time updates on mission-critical events, such as the identification of specific vehicles, confirmation of target make and model, or detection of individuals exiting the vehicle. These voice alerts are customizable, allowing operators to select alert types and adjust the frequency and level of detail based on mission requirements or operator preference.

For enhanced situational awareness, the system's voice accessibility settings can deliver focused updates on detected events in real-time, allowing operators to stay informed without constant visual monitoring. The voice system can be configured to announce particular actions, such as payload deployment readiness, operator confirmations, or key changes in the mission environment. These voice-based notifications, paired with adjustable reporting options, offer an adaptable and accessible interface that supports diverse operational needs, ensuring that critical information reaches the operators when the information is needed in real-time.

In one aspect, the above-described method includes passing mission data, deployment confirmations, and interception data to a central operator dashboard for real-time monitoring, allowing command personnel to view mission-critical information such as vehicle identification, deployment status, and operator commands. This central dashboard, customizable for specific mission requirements, reflects the sources and details of each data point in a modular format.

In one aspect, the mission data generated by the KHOPESH system can be shared with an affiliate or associated law enforcement network, allowing interconnected agencies or support teams to access mission data through secure, permissioned channels. This integration provides collaborative tracking and allows shared systems to view or manage real-time operations when needed.

The KHOPESH server includes a determination module designed to process and determine which segments of mission data-such as vehicle information, license plate confirmation, and GPS location-should be passed to the central command network for mission validation.

In one aspect, the KHOPESH system allows mission data, vehicle tracking information, and deployment commands to be transmitted through multiple formats, including command interfaces accessible via mobile devices, secure SMS or MMS channels, or web-based control interfaces. This ensures that command personnel can access critical information and issue commands through various secure platforms, enhancing accessibility and flexibility in dynamic field environments.

The KHOPESH system is designed to be adaptable, allowing integration with evolving law enforcement tracking systems and analytics providers. This ensures that the system remains compatible with future tracking frameworks or updated control systems, enabling sustained interoperability as new technologies or data protocols are introduced.

The KHOPESH server includes a mission data logging module, which posts completed deployments and vehicle interception confirmations within the central KHOPESH database. This data logging feature ensures all deployment outcomes are recorded, allowing operators and stakeholders to access mission history and validate operation results post-deployment.

In one aspect, the KHOPESH system standardizes the handling of mission and tracking data, treating information equivalently regardless of its source, whether originating from ground sensors, aerial cameras, or operator input devices. This uniform approach to data integration simplifies data processing and ensures consistency across all operational inputs.

In one aspect, the KHOPESH system includes a customizable notification feature that enables operators to receive specific alerts-such as vehicle identification or target exits-in real time. These alerts can be configured to appear on the central dashboard, providing operators with timely information to inform critical decision-making.

In one aspect of the present disclosure, a computer-implemented system for managing drone deployments and payload tracking is provided. The system includes a KHOPESH operational server configured to receive mission-critical data about a target vehicle or area of interest, including identifiers such as vehicle make, model, color, license plate, GPS, and environmental data. The operational server includes a determination module configured to analyze and determine which portions of the operational data are to be passed to a central law enforcement command network or onboard drone systems. The system further includes a redundant system for backup processing to ensure uninterrupted operations during hardware or software failures.

In one aspect, the KHOPESH control code is integrated into the operational interface of the drone system or the modular deployment base station, allowing seamless interaction with other subsystems such as GPS, IMU, and remote activation modules.

In one aspect, the KHOPESH server includes a deployment poster module that records completed drone missions and payload deployments as logged confirmations within the KHOPESH system for operator review. The server also includes a dashboard passing module configured to transmit operational data, deployment confirmations, and mission metrics to a central dashboard accessible by law enforcement agencies and security teams.

In one aspect, the operational data processed by the KHOPESH server can be securely shared with an affiliate law enforcement network, providing external teams access to deployment and mission details through a secure interface.

In one aspect, the KHOPESH system is designed to be adaptable, allowing its modules and data-handling protocols to be updated with future tracking, surveillance, or operational frameworks developed for law enforcement.

In one aspect, the KHOPESH system ensures compatibility across various operational environments. Data processed through the KHOPESH server is standardized, treating mission inputs equivalently whether received from a drone, a modular base station, or a handheld operator device.

In one aspect, KHOPESH's system functionality may be implemented using hardware, firmware, software, or a combination of these technologies. The payload device processing may be executed on a proprietary PCB within the spike strip, integrating components such as a microcontroller, IMU, or GPS. The system may also include redundant PCBs for backup functionality, ensuring reliability during critical operations.

In one aspect, the software instructions for the KHOPESH system may reside on computer-readable media such as RAM, ROM, or EEPROM within the PCB or external devices. These instructions can be transmitted via secure communication media to update firmware or execute commands dynamically during missions.

In one aspect, the specific sequence of steps in KHOPESH operations is designed to be flexible. The order of actions-such as scanning, vehicle identification, operator confirmations, and payload deployment-can be rearranged or adapted based on operator's needs, mission parameters or preferences.

In one aspect, the KHOPESH system utilizes machine-readable media to store data structures or programs that guide an aerial drone's behavior. Additionally, signals indicative of mission updates and commands may be transmitted via secure channels to ensure seamless operations.

The present disclosure is not limited to the specific configurations or methods described. Processes, machines, or systems that perform similar functions or achieve comparable results may also be utilized within the scope of the disclosure, ensuring KHOPESH remains adaptable to evolving operational requirements.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors.

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

For a firmware and/or software implementation, the methodologies may be implemented with modules (e.g., procedures, functions, and so on) that perform the functions described herein. A machine-readable medium tangibly embodying instructions may be used in implementing the methodologies described herein. For example, software codes may be stored in a memory and executed by a processor unit. Memory may be implemented within the processor unit or external to the processor unit. As used herein, the term “memory” refers to types of long term, short term, volatile, nonvolatile, or other memory and is not to be limited to a particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include RAM, ROM, EEPROM, CD-ROM or other optical disk storage, magnetic disk storage or other magnetic storage devices, or other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on a computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the technology of the disclosure as defined by the appended claims. For example, relational terms, such as “above” and “below” are used with respect to a substrate or electronic device. Of course, if the substrate or electronic device is inverted, above becomes below, and vice versa. Additionally, if oriented sideways, above and below may refer to sides of a substrate or electronic device. Moreover, the scope of the present application is not intended to be limited to the particular configurations of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding configurations described herein may be utilized according to the present disclosure. Accordingly, the appended claims are intended to include within their scope such processes, machines, manufacture, compositions of matter, means, methods, or steps.

The present disclosure and its advantages have been described, it should be understood that various changes, substitutions, and alterations can be made herein without departing from the scope of the invention as defined by the appended claims.

The present disclosure also pertains to the wireless communication technologies necessary for the drone to communicate with the server and subsequently the operator. This includes cloud-based processing and remote computing to enable real-time data analysis, decision-making, and system scalability. The scope of this patent includes, but is not limited to, methods that ensure the safe and reliable operation of the system.

These methods encompass encryption protocols to secure data transmissions, server security measures to prevent unauthorized access, and obstacle avoidance technologies to ensure safe navigation in dynamic environments.

Additionally, the disclosure includes safety measures designed to maintain operational integrity during events such as power loss or signal jamming, as well as electronic countermeasures to detect and mitigate hacking attempts. The system's use of advanced server security protocols and cloud-based redundancy ensures data integrity and continuity. These features collectively contribute to a robust and adaptable system capable of performing reliably in a wide range of operations in an effort to improve public safety.

What is claimed is:

1. An unmanned aerial system comprising:
a payload device equipped with a printed circuit board (PCB) configured for:
data processing;
transmitting its location;
detecting impacts; and
controlling a high-amperage servo;
a set of artificial intelligence/machine learning (AI/ML) models stored on the PCB for object detection, real-time surveillance, and threat analysis;
software modules for training the AI/ML models onboard the payload device; hollow spikes with integrated magnets attached to the payload device, wherein the hollow spikes are configured to penetrate tires and deflate them safely at a controlled rate while being easily replaceable;
magnetic electrical connectors facilitating power and data exchange;
helium gas exchange connections for providing positive lift/buoyancy and increasing battery efficiency and flight time;
a drone configured to receive data from the payload device and communicate with a base unit; and
a base unit mountable on vehicles or ground structures designed for all-weather operations, capable of charging multiple payload devices and the drone simultaneously, wherein the unmanned aerial system utilizes the AI/ML models and the magnetic connections to perform tasks autonomously.

2. The unmanned aerial system of claim 1, wherein the AI/ML models are trained in real-time using the onboard software modules based on environmental data collected by the payload device.

3. The unmanned aerial system of claim 1, wherein the software for consumers/end-users allows remote monitoring and control of the payload device via a user interface.

4. The unmanned aerial system of claim 1, wherein the PCB includes sensors for collecting data used to update the AI/ML models during operation.

5. The unmanned aerial system of claim 1, wherein the hollow spikes are designed to penetrate tires and deflate them safely at a controlled rate while being easily replaceable.

6. The unmanned aerial system of claim 1, wherein the magnetic electrical connectors are configured to automatically align and connect upon proximity to compatible connectors on the base unit.

7. The unmanned aerial system of claim 1, wherein the helium gas exchange connections are used to provide positive lift/buoyancy and increase battery efficiency and flight time.

8. The unmanned aerial system of claim 1, wherein the base unit includes charging capabilities for the payload device and the drone via the magnetic electrical connectors.

9. The unmanned aerial system of claim 1, wherein the base unit is equipped with weather-resistant features allowing operation in adverse weather conditions.

10. A method for autonomous operation of an unmanned aerial system, comprising:
deploying a payload device with onboard AI/ML models and training software;
using hollow spikes with magnets to penetrate tires and deflate them safely at a controlled rate while being easily replaceable;
exchanging power and data through magnetic electrical connectors;
providing positive lift/buoyancy and increasing battery efficiency and flight time via helium gas exchange connections;
processing environmental data on the PCB to update AI/ML models for object detection, real-time surveillance, and threat analysis;
transmitting payload device data to the drone;
transmitting drone data to the base unit; and
charging multiple payload devices and the drone simultaneously at the base unit.

11. The method of claim 10, further comprising remotely updating the AI/ML models through consumer/end-user software interfaces.

12. The method of claim 10, wherein the payload device autonomously returns to the drone when power levels are low.

13. The method of claim 10, wherein the base unit collects data from multiple drones for centralized processing.

14. The method of claim 10, wherein the software for training includes machine learning algorithms for pattern recognition specific to the payload device's operational environment.

15. A payload device for an unmanned aerial system, comprising:
a PCB with integrated AI/ML models configured for object detection, real-time surveillance, and threat analysis;
software for onboard training and data processing;
hollow spikes with magnets designed to penetrate tires and deflate them safely at a controlled rate while being easily replaceable; and
magnetic electrical and helium gas exchange connectors, wherein the payload device operates autonomously based on processed data.

16. The payload device of claim 15, wherein the hollow spikes are designed to detach and be easily replaced after deflation of a tire.

17. The payload device of claim 15, wherein an electromagnet is part of the deployment mechanism for attaching the payload device to the drone or the base unit.

18. The payload device of claim 15, further comprising environmental sensors connected to the PCB for data collection.

19. A drone for use with an unmanned aerial system, comprising:
communication modules configured to receive data from the payload device and transmit data to the base unit;
charging ports compatible with magnetic electrical connectors for charging multiple payload devices and the drone simultaneously; and
a housing designed to accommodate one or more payload devices, wherein the drone communicates autonomously with the base unit and manages multiple payload devices during operation.

20. The drone of claim 19, wherein the drone includes propulsion systems enhanced by helium gas exchange connections to provide positive lift/buoyancy and increase battery efficiency and flight time.
